(19) United States
(12) Patent Application Publication
(10) Pub. No.: US 2005/0045431 A1
(43) Pub. Date: Mar. 3, 2005

(54) Car for elevator

(76) Inventor: Shun Fujimura, Tama-Shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/495,129

(22) PCT Filed: Nov. 21, 2003
(86) PCT No.: PCT/JP03/14926

(30) Foreign Application Priority Data
Dec. 9, 2002 (JP) 2002-356955

(51) Int. Cl. B66B 11/02

(52) U.S. Cl. 187/401; 187/403

(57) ABSTRACT

A car 1 for an elevator that moves vertically along a guide rail comprises a car body 1a, an upper beam 2 disposed above the car body 1a, a car frame 3 connected to the upper beam 2 and holding the car body 1a. A guide rail lubricating device 8 is place within the upper beam 2 and is provided with an oil feeding tank 8a. The oil feeding tank 8a is supported on the top wall of the car body 1a by a guide means 6.

### TECHNICAL FIELD

The present invention relates to a car for an elevator that moves vertically along guide rails and, more particularly, to a car provided with a guide rail lubricating device.

### BACKGROUND ART

An elevator car that moves vertically along guide rails is provided with a guide rail lubricating device. The guide rail lubricating device is connected to the upper surface of an upper beam of the car by a guide means.

If the OH dimension of a machine-roomless elevator system provided with a guide rail lubricating device mounted on the car by the conventional mounting method is designed under the same design conditions as the conventional machine-roomless elevator system, the entire system cannot be properly disposed due to an overhead clearance needed to cope with the overshooting of the car. Therefore, the height of the car needs to be reduced or the OH dimension needs to be increased.

However, the reduction of the height of the car will adversely affect passenger comfort by creating an oppressive feeling for those in the car. In such a case, conditions for OH dimension must be satisfied by properly constructing the frame of the car.

### DISCLOSURE OF THE INVENTION

The present invention has been made in view of such problems and it is therefore an object of the present invention to provide a car for an elevator that provides the overhead clearance necessary for the overshooting of the car against the upper surface of the upper beam of the car, while minimizing the reduction of the height of the car.

According to the present invention, a car for an elevator comprises a car body; an upper beam disposed above the car body; a car frame connected to the upper beam and holding the car body; and a sheave support beam supporting sheaves and disposed between a top wall of the car and the upper beam; wherein a guide rail lubricating device is placed within the upper beam and is supported on the top wall of the car body by a guide means.

In the car for an elevator according to the present invention, the upper beam is extended horizontally above the car body.

In the car for an elevator according to the present invention, the sheave support beam is connected to a lower surface of the upper beam, and the sheaves are supported for rotation on the opposite ends of the sheave support beam, respectively.

In the car for an elevator according to the present invention, the guide rail lubricating device has an oil feeding tank supported by a bracket on the upper surface of the guide means.

In the car for an elevator according to the present invention, auxiliary oil feeding tanks are placed within the upper beam.

In the car for an elevator according to the present invention, the auxiliary oil feeding tanks are connected to the oil feeding tank by pipes.

In the car for an elevator according to the present invention, the oil feeding tank is provided with a slide lid or a swing lid.

In the car for an elevator according to the present invention, the number of the sheaves is at least two, and the sheaves are on the opposite sides, respectively, of the upper beam in a horizontal plane.

### BRIEF DESCRIPTION OF THE DRAWINGS

FIG. 1 is a perspective view of a car for an elevator, according to the present invention;

FIG. 2 is an enlarged view of an upper part of the car shown in FIG. 1;

FIGS. 3(a) and 3(b) are views of assistance in explaining a lid structure included in an oil feeding tank; and

FIGS. 4(a) and 4(b) are views of assistance in explaining a lid structure included in an auxiliary oil feeding tank.

### BEST MODE FOR CARRYING OUT THE INVENTION

Preferred embodiments of the present invention will be described with reference to the accompanying drawings.

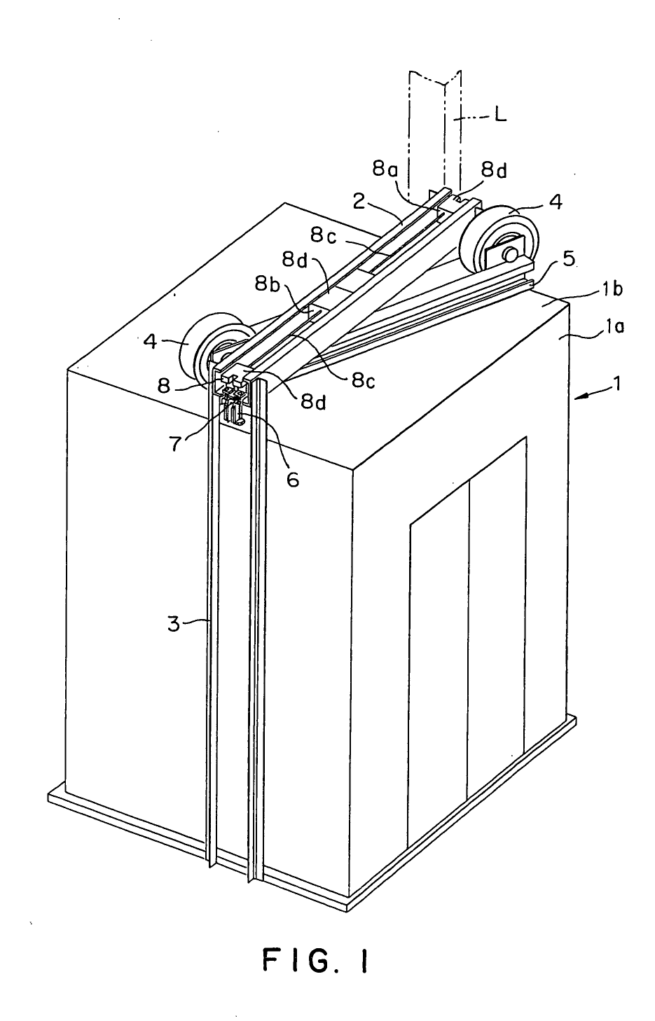

FIGS. 1 to 4 are views of assistance in explaining a car in a preferred embodiment according to the present invention for an elevator.

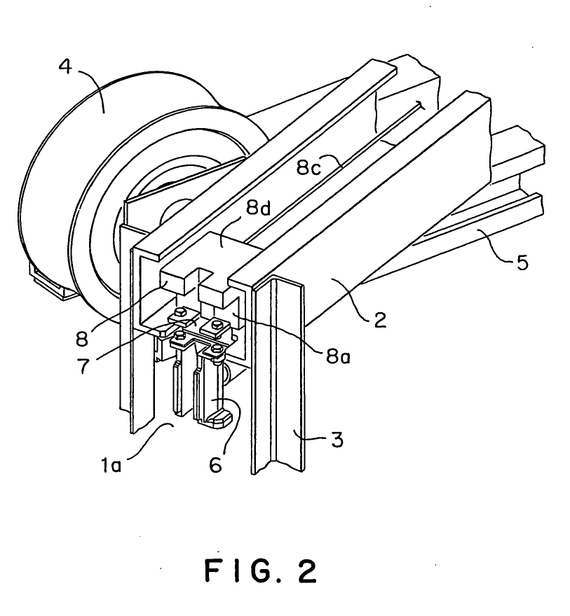

Referring to FIGS. 1 and 2, a car 1 for an elevator moves vertically along a guide rail L, the car 1 is connected to a counterweight by a rope not shown.

The car 1 includes a car body 1a having a top wall 1b, an upper beam 2 horizontally extended above the car body 1a, and a car frame 3 connected to the upper beam 2 and holding the car body 1a. A sheave support beam 5 is connected to a substantially middle part of the upper beam 2. The sheave support beam 5 is fixed to a lower surface of the upper beam 2. Sheaves 4 are supported for rotation on the opposite ends of the sheave support beam 5.

The sheave support beam 5 is disposed between the top wall 1b of the car body 1a, and the upper beam 2, and the sheaves 4 are on the opposite sides, respectively, of the upper beam 2 in a horizontal plane.

The upper beam 2 is a hollow beam formed by combining a pair of members having a U-shaped cross section. A guide rail lubricating device 8 is placed within the upper beam 2.

The guide rail lubricating device 8 has an oil feeding tank 8a. The oil feeding tank 8a is supported by a guide structure 6 and a bracket 7 on the upper surface of the car body 1a. The guide structure 6 includes a guide shoe, a roller guide, an isolation guide or the like.

A plurality of auxiliary oil feeding tanks 8b may be placed within the upper beam 2. The auxiliary oil feed tanks 8b are connected to the oil feeding tank 8a by pipes 8c. Oil is fed from the oil feeding tank 8a and the auxiliary oil feeding tanks 8b through the pipes 8c to the guide rail L.

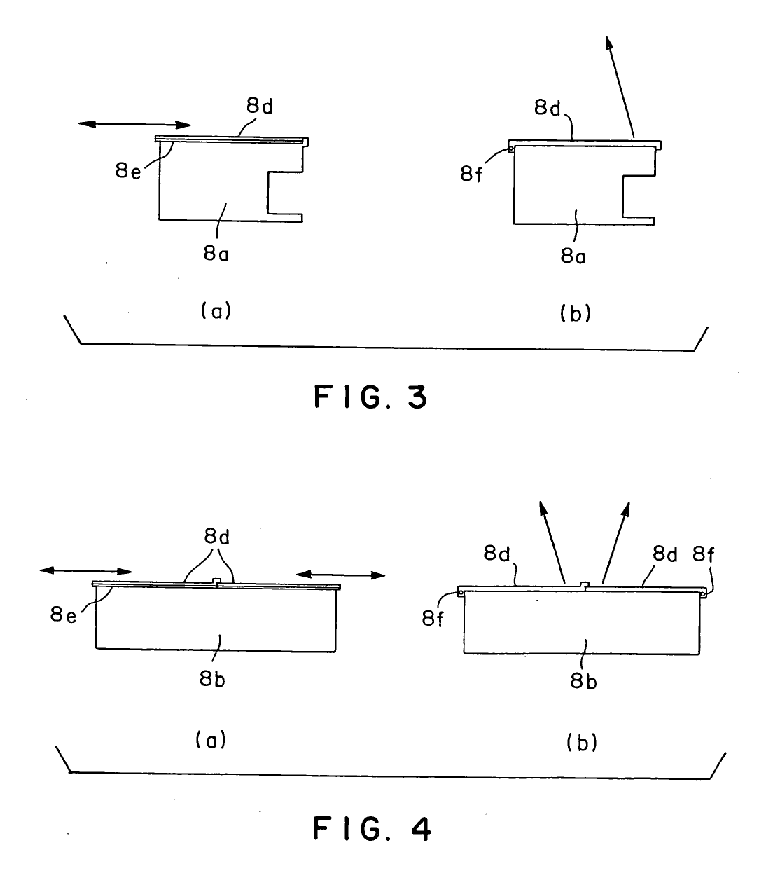

Lid structures included in the oil feeding tank 8a and the auxiliary oil feeding tanks 8b will be described with reference to FIGS. 3(a), 3(b), 4(a) and 4(b).

A slide lid 8d is slidably inserted in grooves 8e formed in the oil feeding tank 8a as shown in FIG. 3(a). A swing lid 8d may be connected to the oil feeding tank 8a by a hinge 8f as shown in FIG. 3(b).

Slide lids 8d are slidably inserted in grooves 8e formed in the auxiliary oil feeding tank 8b as shown in FIG. 4(a). Swing lids 8d may be connected to the auxiliary oil feeding tank 8b by hinges 8f as shown in FIG. 4(b).

Referring to FIGS. 1 to 4, the guide structure 6 is disposed between the lower surface of the upper beam 2 and the top wall 1b of the car body 1a. The guide rail lubricating device 8 is held by the guide structure 6 and the bracket 7 on the top wall 1b of the car body 1a so as to be housed in the upper wall 2. Therefore, an overhead clearance to cope with the overshooting of the car body 1a can be determined with respect to the upper surface of the upper beam 2. Consequently, all the system can be properly disposed without reducing the height of the car body 1a and without increasing OH dimension.

Even if the height of the upper beam 2 is reduced on account of strength calculation, the guide rail lubricating device 8 can be housed within the upper beam 2 by changing the height of the bracket 7.

Since the oil can be fed to the guide rail L from the plurality of auxiliary oil feeding tanks 8b, the oil can be stably fed by replenishing the auxiliary oil feeding tanks 8b with the oil by maintenance work. Vacant spaces in the upper beam 2 can be used as auxiliary oil feeding tanks 8b to reduce the frequency of replenishing the auxiliary oil feeding tanks 8b with the oil.

Since the oil feeding tank 8a and the auxiliary oil feeding tanks 8b are provided with the slide lids 8d slidably inserted in the grooves 8e or the swing lids 8d connected by hinges 8f thereto, the oil feeding tank 8a and the auxiliary oil feeding tanks 8b do not need to be removed from the upper surface of the car body 1a, which facilitates maintenance work.

As apparent from the foregoing description, according to the present invention, the overhead clearance to cope with the overshooting of the car can be determined with respect to the upper surface of the upper beam, and therefore the reduction of the height of the car can be minimized to the least extent.

1. A car for an elevator, comprising:
a car body;
an upper beam disposed above the car body;
a car frame connected to the upper beam and holding the car body; and
a sheave support beam supporting sheaves and disposed between a top wall of the car and the upper beam;
wherein a guide rail lubricating device is placed within the upper beam and is supported on the top wall of the car body by a guide means.

2. The car for an elevator according to claim 1, wherein
the upper beam is extended horizontally above the car body.

3. The car for an elevator according to claim 1, wherein
the sheave support beam is connected to a lower surface of the upper beam, and the sheaves are supported for rotation on the opposite ends of the sheave support beam, respectively.

4. The car for an elevator according to claim 1, wherein
the guide rail lubricating device has an oil feeding tank supported by a bracket on the upper surface of the guide means.

5. The car for an elevator according to claim 4, wherein
auxiliary oil feeding tanks are placed within the upper beam.

6. The car for an elevator according to claim 5, wherein
the auxiliary oil feeding tanks are connected to the oil feeding tank by pipes.

7. The car for an elevator according to claim 4, wherein
the oil feeding tank is provided with a slide lid or a swing lid.

8. The car for an elevator according to claim 1, wherein
the number of the sheaves is at least two, and the sheaves are on the opposite sides of the upper beam in a horizontal plane respectively.
